(19) United States
(12) Patent Application Publication
(10) Pub. No.: US 2012/0261164 A1
(43) Pub. Date: Oct. 18, 2012

(54) Electric fence wire insulator

(76) Inventor: Thomas Robert McKinnon, Albany, GA (US)

(21) Appl. No.: 13/066,390

(22) Filed: Apr. 13, 2011

(51) Int. Cl. H01B 17/14

(52) U.S. Cl. 174/158 F

(57) ABSTRACT

An insulator for supporting an electrically charged fence wire on a T-post having a post flange and a post web. The insulator having a shank separating a web clip on one shank end and a flange clip on the other shank end to enable the insulator to protrude from either the flange or the web side of the post. Two pairs of wire support fingers are provided, each of the pairs protruding from a respective one of either the web clip or the flange clip, the fence wire being attached to the pair of support fingers on the web clip or the flange clip that is not joined to the T-post.

### CROSS REFERENCE TO RELATED APPLICATION

Thomas R. McKinnon Design Patent Application Titled “Electric Fence Wire Insulator” Filed of Even Date Herewith

### FEDERALLY SPONSORED RESEARCH OR DEVELOPMENT

None

### NAMES OF PARTNERS TO JOIN RESEARCH AGREEMENT

None

### REFERENCE TO “SEQUENCE LISTING”

None

### BACKGROUND OF THE INVENTION

This invention relates to electrical insulators for electrified wire fences supported by T-posts and, more particularly, to T-post retainer clips formed on opposite ends of an insulator shank with two sets of pairs of fingers that have oppositely oriented wire supports, the individual pairs of fingers each being mounted on the end of a respective one of the retainer clips, and the like.

Fences for restraining livestock to remain, for example, in specific grazing areas are frequently electrified. One or more strands of electrified wire, supported at intervals by metal T-posts apply a mild shock to any livestock venturing against one of these electrified strands. Naturally, the electrified strand must be insulated from the supporting T-posts, or the strand will be “grounded” or “short-circuited” and thus be incapable of supplying the necessary electrical shock to the enclosed livestock. Through the years, to provide this electrical insulation, several different insulator designs have been developed. Illustratively, to mount these insulators on a T-post, the T-post clips on the insulators are adapted to clutch specific parts of the customary T-post.

Because of the web and flange T-post shape, however, these insulators are available only to support an electrified wire either on the side of the T-post web or on the side of the T-post flange. Consequently, the need to support and insulate an electrified wire on either the web or the flange side of the T-post determines which of the two types of insulator will be required. Because of the unique nature of the T-post cross section it is not possible simply to invert an insulator in order to enable it to protrude from an opposite T-post side.

As a practical matter, the stockman is required to purchase supplies of insulators in lots of not less than twenty five, the insulators being packaged as either T-post web or flange side units. This frequently leaves the purchaser with a surplus of insulators having an orientation relative to the T-post that is not needed.

Accordingly, there is a need to avoid the expense and inconvenience of buying more insulators that are required with an unnecessary T-post orientation.

### BRIEF DESCRIPTION OF THE INVENTION

These, and other disadvantages of the prior art are overcome to a great extent through the practice of the invention.

For example, in an illustrative embodiment of the invention, a shank of electrically insulating material has on one end a T-Post web clip, largely for attachment to the T-post web and wire support. In addition, formed on the other end of the shank is a T-post flange clip, for T-post flange attachment. In accordance with a salient feature of the invention, two wire support finger sets are provided, in which each set has two wire support fingers each of which finger sets are mounted on the extremities of the respectively associated T-post clips. The individual fingers in each of the sets also have oppositely oriented slots to support an electrified wire.

Thus, a web clip mounted on a T-post, has a shank with a protruding flange clip, and it is the set of wire support fingers on the flange clip that support the electrified wire. In a similar manner, in those instances in which the flange clip engages the T-post, it is the set of fingers on the extremity of the web clip that support the electrified wire.

These and other features of the invention are described in more complete detail in the following description of a preferred embodiment of the invention when taken with the figures of the drawing. The scope of the invention, however, is limited only through the claims appended hereto.

### BRIEF DESCRIPTION OF THE DRAWING

FIG. 1 is a perspective view of an exemplary embodiment of the invention showing the flange and the web clips mounted on a T-post;

FIG. 2 is a plan view of a typical embodiment of the invention;

FIG. 3 is a plan view of the web clip for the embodiment of the invention shown in FIG. 2 engaging a T-post flange;

FIG. 4 is a plan view of the embodiment of the invention shown in FIGS. 2 and 3, fully mounted on a T-post web to support an insulated electrified wire.

FIG. 5 is a plan view of a typical embodiment of the invention;

FIG. 6 is a plan view in transverse cross-section of a typical T-post taken along the line 6-6 of FIG. 1 and viewed in the direction of the arrows; and

FIG. 7 is a side elevation of the embodiment invention shown in FIG. 5.

### DETAILED DESCRIPTION OF A PREFERRED EMBODIMENT OF THE INVENTION

Attention is invited to FIG. 6 of the drawing which shows, in transverse section, a typical T-post 10. The T-post 10 is one of a number of fence support stakes (not shown) longitudinal ends of which are driven into the ground to support the electrically charged fence as described later in more complete detail. A straight web 11 is joined at end 12 to an arcuate flange 13 having openly curved arms 14, 15 that protrude from opposite sides of the web end 12. A boss 16 is spaced longitudinally from the transverse section and is one of several bosses spaced at uniform distances of about two inches from each other along the length of the T-post 10 (only the boss 16 being shown in FIG. 6).

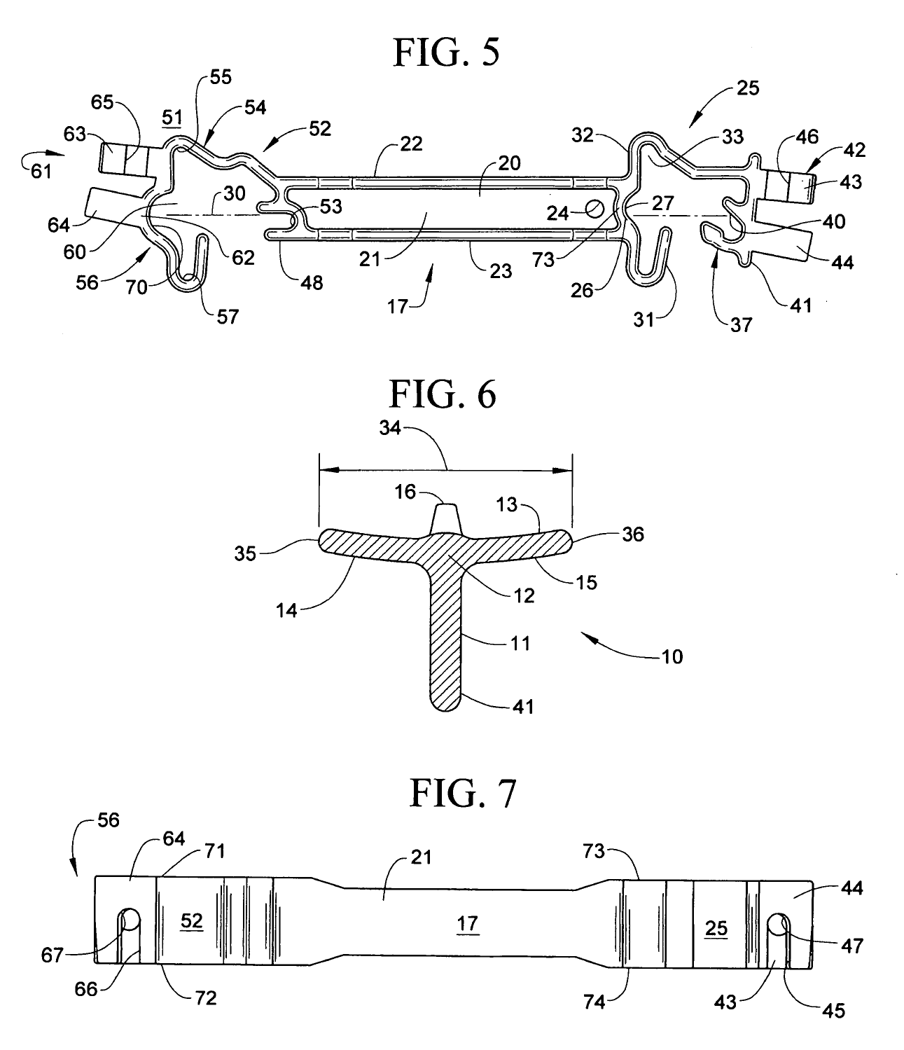

As best shown in FIG. 5, an insulator 17 formed preferably from a suitably stiff, but resilient electrically insulating plastic has a shank 20, formed in the shape of a wide flange beam having a web 21 that is joined to oppositely disposed flanges 22, 23. A hole 24, moreover is formed in the web 21 near a flange clip 25 at one end of the shank 20.

The flange clip 25, at junction 26 with the shank 20 has a flange recess 27, the recess 27 being perpendicular to longitudinal axis 30 for the shank 20 and in alignment with the axis 30.

As shown in FIG. 5, the flange clip 25 has a resilient clamp 31 for containing both sides of the flange arm 14 (FIG. 6). Returning to FIG. 5, on the side of the flange clip 25 that is opposite to the clamp 31, another resilient flange clamp 32 is formed to engage the web arm 15 (FIG. 6). The flange clamps 31, 32 form a gap 33 (FIG. 5) to establish a separation between the opposing clamps 31, 32. The gap 33 is slightly smaller than linear distance 34 (FIG. 6) between the respective extremities 35, 36 on the web arms 14, 15.

Continuing with the description of the flange clamp 32, a portion 37 extends beyond the clamp 32 to provide a resilient web clamp 40 that is angularly offset relative to the longitudinal axis 30. When extended, however, to receive a suitable portion of end 41 (FIG. 6) of the web 11 the angular offset is pressed into general alignment with the longitudinal axis 30. At the end of the portion 37 for the flange clamp 32, and on the side of the flange clamp 32 that is opposite to the web clamp 40 a flange side finger set 42 is formed. The finger set 42 has a pair of spaced apart and generally parallel fingers 43, 44. Best shown in FIG. 7, the finger 44 has an inverted “U” shaped recess 45 that is parallel with and overlaps a corresponding and upright “U” shaped recess 46 (FIG. 5) in the finger 43. The overlap between the recess 45 (FIG. 7) and the recess 46 (FIG. 5) define a circular passageway 47 (FIG. 7) between the fingers 43, 44 for supporting a fence wire 50 (FIG. 4).

Attention now is invited to FIG. 5 and web side 51 that is at end 48 of the longitudinal axis 30 of the shank 20 opposite to the flange clips 25. A web clip 52 is provided on the end 48 of the shank 20, the web clip 52 having a web recess 53 that is formed in the shank 20 with an end of the shank flange 23 providing one side of the recess 53. Further in this respect, the recess 53 is offset from and parallel with the longitudinal axis 30 of the shank 20. The depth of the recess 53 is sufficient to engage and retain a suitable portion of the web end 41 (FIG. 6) of the T-post 10.

The shank flange 22, moreover, extends beyond the end 48 of the shank 20 to form a resilient flange clip 54 for engaging the arm 15 of the T-post flange 13 (FIG. 6) in a flange recess 55 (FIG. 5). Opposite to the recess 55, the web clip 52 has a further portion 56, curved to form a flange recess 57 that is opposite to the flange recess 55. As illustrated in FIG. 5, both of the flange recesses 55, 57 are angularly offset relative to the longitudinal axis 30 of the shank 20. Further, gap 60 formed between the flange recesses 55, 57 is slightly smaller than the linear distance 34 (FIG. 6) between the T-post extremities 35, 36 in order to grip securely the T-post flange 13 (FIG. 6) within the recesses 55, 57 (FIG. 5).

A web side finger set 61 also is provided on a flange clamp portion 62 of the flange clip 54 that forms and connects together the recesses 55, 57. Further in this respect, the finger set 61 is mounted on the side of the flange clamp portion 62 that is opposite to the recesses 55, 57.

In a manner similar to that described above with respect to the fingers 43, 44 on the flange clip 25, the flange clamp finger set 61 has a pair of protruding fingers 63, 64. The finger 63 has an upright, U-shaped recess 65 that is parallel with and spaced from an inverted U-shaped recess 66 (FIG. 7) formed in the finger 64 to provide a circular overlap 67 of the recesses 65, 66 to support a fence wire (not shown in FIGS. 5 and 7).

A web recess 70, angularly offset relative to the longitudinal axis 30 of the shank 20 is formed in the flange clamp portion 62, on the side of the portion 62 that is opposite to the finger set 61. When the flange clamp 54 clasps both of the arms 14, 15 of the T-post flange 13 (FIG. 6) in the recesses 55, 57 (FIG. 5) the resiliency of the web clip 52 presses the recess 70 into an alignment that is generally parallel with the axis 30 and the web recess 53. As best shown in FIG. 7, the web clip further portion 56 also provides web abutments 71, 72 on opposite surfaces of the web recess 70 (FIG. 5). Further in this respect, flange abutments 73, 74 (FIG. 7) also are formed on opposite surfaces of the flange recess 27.

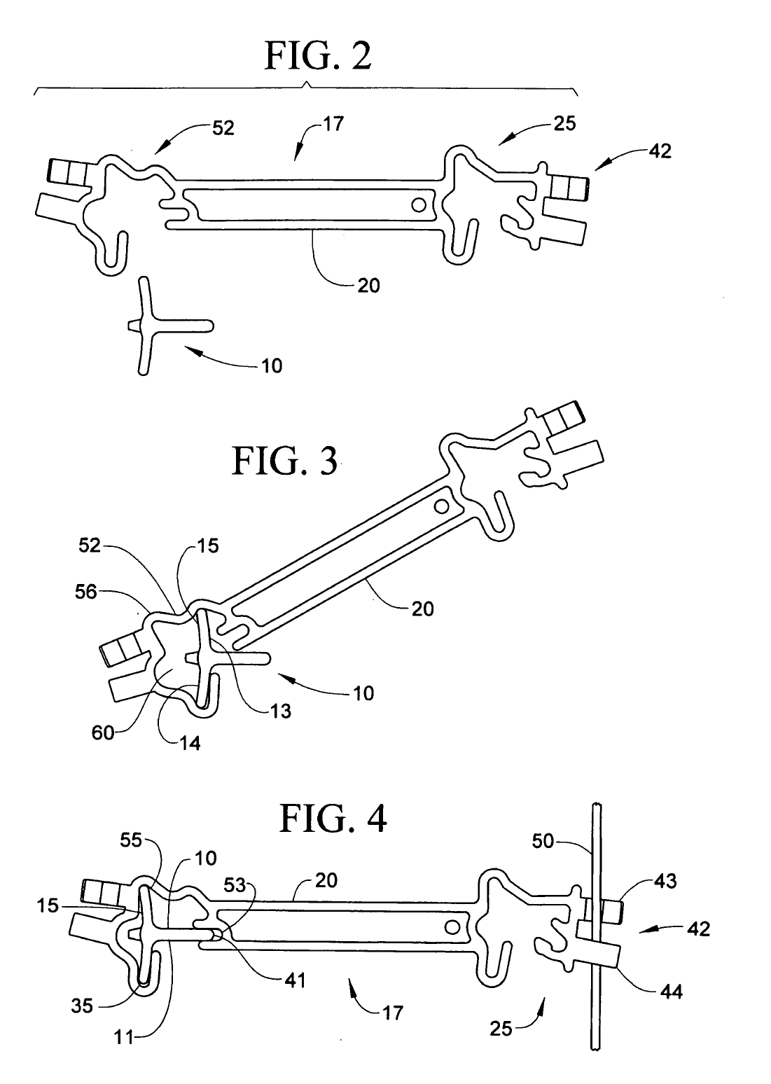

In operation, and as illustrated in FIG. 2, the T-post 10 is to be inserted into the web clip 52 on the insulator 17 to enable the fence wire 50 (FIG. 4) to be supported by the flange finger set 42 that protrudes from the flange clip 25 on the opposite side of the shank 20. Thus, the insulator 17, formed from stiff but suitably pliable electrically insulating material isolates the fence wire 50 electrically from the electrically conductive steel T-post 10 to prevent the current in the fence wire 50 from being “grounded” or “short circuited” to the ground through the conductive steel of the T-post 10.

Illustrated in FIG. 3, the web clip further side portion 56 is bent in a clock-wise direction relative to the shank 20 to enable the web arms 14, 15 of the flange 13 on the T-post 10 to fit into the gap 60 between the recesses 55, 57. Note in this respect, that the clockwise bending of the web clip 52 is not restored when the web end 41 of the T-post 10 (FIGS. 3 and 4) is fully seated in the web clip 52. These unrelieved stresses, however, increase the friction force between the web clip 52 and those portions of the T-post 10 that are in physical contact with the web clip 52. Consequently, the angular offset of the web clip 52 relative to the longitudinal axis 30 (FIG. 5) of the shank 20 increases the force with which the insulator 17 maintains its position on the T-post 10. When the arm 15 (FIG. 4) for the T-post flange 13 is seated in the recess 55 and the extremity 35 of the T-post arm 14 is received in the recess 57, the end 41 of the T-post web fits into the web recess 53 in the shank 20.

The electrically conductive fence wire 50 is inserted into the flange finger set 42 (FIGS. 4, 5 and 7). The inverted and upright recesses 45, 46 formed in the respective fingers 44, 43 will support the fence wire 50 (FIG. 4) in spite of the upright or inverted orientation of the insulator 17 relative to the T-post 10, in that the fence wire 50 always will have a portion of one of the two fingers 43, 44 to hold the fence wire above ground.

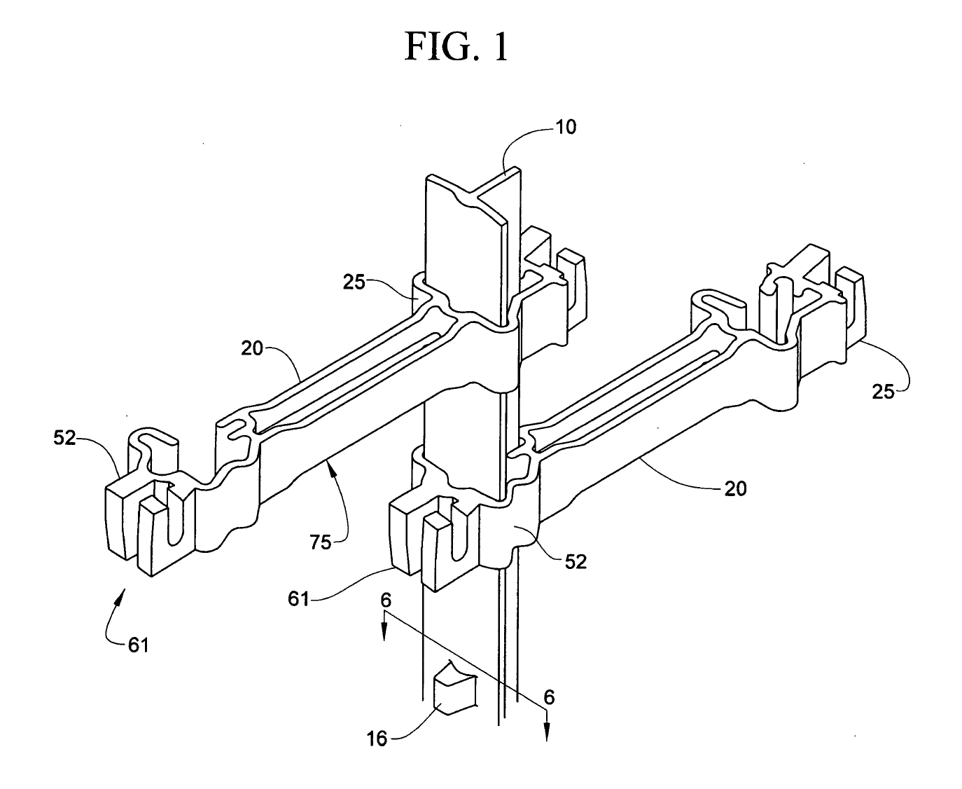

To mount the flange clip 25 on the T-post 10, essentially the same procedure is followed as that which is described above with respect to the web clip 52 and the T-post 10 assembly process. Thus, as shown in FIG. 1, and in accordance with a feature of the invention the flange clip 25 is secured to the T-Post 10, the shank 20 protruding away from the T-post 10 with the web clip 52 on the insulator 17. With respect to the flange clip 25, the web finger set 61 on the web clip 52 now is available to mount the fence wire 50 (not shown in FIG. 1).

Attention now is invited to the boss 16 (FIGS. 1 and 6). When the web clip 52 (FIG. 7) is attached to the T-post 10 (FIG. 1), the boss 16 can bear against the web abutment 71 (FIG. 7) to prevent the insulator 17 from sliding down the length of the T-post 10.

In a similar manner, the flange abutment 23 on the flange clip 25 also prevents the insulator 17 from sliding down the T-post 10 when the flange clip 25 is coupled to the T-post 10. Should the insulator 17 be inverted relative to the orientation shown in FIG. 7, however, it is the abutment 74 that can press against the boss 16 (FIG. 6) when the flange clip 25 (FIG. 7) is clutching the T-post 10; or it is the abutment 72 when the web clip 52 is secured to the T-post 10 that keeps the insulator 17 in its position on the T-post 10.

Note, moreover, that the hole 24 (FIG. 5) formed in the web 21 for the shank 10 permits electrically conductive rainwater, dew, melting snow, ice and the like to drain away from the insulator 17, thus preventing weather or other natural conditions from degrading the electrical insulating character of the insulator 17.

In summary, by providing finger sets on the clips that are formed on opposite ends of an insulator shank, the insulator that characterizes the invention supports an electrified fence wire with finger sets that are formed on the clip that is not attached to the T-post. In this way, only one insulator need be purchased for attachment to either or both sides of a T-post.

1. An electrical insulator for selectively supporting a fence wire on both sides of a web and flange post with protruding bosses spaced from each other longitudinally along the length of the post comprising, a flange clip for attachment to the post flange, a pair of flange clip fingers on said flange clip for supporting the fence wire, a web clip for attachment to the post web, a pair of web clip fingers on said web clip for supporting the fence wire, and a shank interposed between said flange clip and said web clip to enable said flange clip fingers and said web clip fingers selectively to support the fence wire as the web clip and the flange clip, respectively, are attached to the post.

2. An insulator according to claim 1 further comprising a first flange clamp on said flange clip for engaging at least a portion of the post flange, another flange clamp on said flange clip spaced from said first flange clamp for selectively clamping the post flange therebetween.

3. An insulator according to claim 2 further comprising a web clamp on said flange clip for selectively engaging at least a portion of the post web,

4. An insulator according to claim 2 further comprising a first flange clamp on said web clip for selectively engaging at least a portion of the post flange, another flange clamp on said web clip, spaced from said first post flange clamp for selectively clamping the post flange therebetween.

5. An insulator according to claim 4 further comprising a web clamp on said web clip for selectively engaging at least a portion of the post web.

6. An insulator according to claim 1 further comprising abutment on said flange clip for bearing against one of the post bosses to prevent the insulator from moving along the length of post.

7. An insulator according to claim 1 further comprising an abutment on said web clip for bearing against one of the post bosses to prevent the insulator from moving along the length of the post.

8. An electrical insulator for supporting a fence wire selectively on both sides of a web and flange post with protruding bosses spaced longitudinally along the length of the post comprising, a flange clip for attachment to the post, a pair of flange clip fingers on said flange clip for supporting the fence wire, a first flange clamp on said flange clip for engaging at least a portion of the post flange, another flange clamp on said flange clip spaced from said first flange clamp for clamping the post flange therebetween, a web clamp on said flange clip for engaging at least a portion of the post web, a web clip for attachment to the post, a pair of web clip fingers on said web clip for supporting the fence wire, a first web clip flange clamp on said web clip for engaging at least a portion of the post flange, another web clip flange clamp on said web clip spaced from said first web clip flange clamp for selectively clamping the post flange therebetween, a web clip web clamp on said web clip for engaging at least portion of the post web, a pair of web clip fingers on said web clip for supporting the fence wire, an abutment on said flange clip for bearing against one of the post bosses to prevent the insulator from moving along the length of the post, an abutment on said web clip for bearing against one of the post bosses to prevent the insulator from moving along the length of the post, and a shank interposed between said flange clip fingers and said web clip fingers to support the fence wire selectively as the web clip and the flange clip, respectively, are attached to the post.

9. An electrical insulator for selectively supporting a fence wire on both sides of a web and flange post with protruding bosses spaced from each other longitudinally along the length of the post comprising, a flange clip forming one side of the insulator for attachment to the post flange, a pair of flange clip fingers on said flange clip for supporting the fence wire, a web clip forming another side oft he i nsulator for attachment to the post web, a pair of web clip fingers on said web clip for supporting the fence wire, said flange clip fingers and said web clip fingers selectively supporting the fence wire as said web clip and said flange clip, respectively, are attached to the post.

10. An insulator according to claim 9 further comprising a first flange clamp on said flange clip for engaging at least a portion of the post flange, another flange clamp on said flange clip spaced from said first flange clamp for selectively clamping the post flange therebetween.

11. An insulator according to claim 10 further comprising a web clamp on said flange clip for selectively engaging at least a portion of the post web.

12. An insulator according to claim 9 further comprising a first flange clamp on said web clip for selectively engaging at least a portion of the post flange, another flange clamp on said web clip spaced from said first post flange clamp for selectively clamping the post flange therebetween.

13. An insulator according to claim 12 further comprising a web clamp on said web clip for selectively engaging at least a portion of the post web.

14. An insulator according to claim 9 further comprising an abutment on said flange clip for bearing against one of the post bosses to prevent the insulator from moving along the length of the post.

15. An insulator according to claim 14 further comprising an abutment on said web clip for bearing against one of the post bosses to prevent the insulator from moving along the length of the post.
